(19) United States
(12) Patent Application Publication
(10) Pub. No.: US 2014/0236637 A1
(43) Pub. Date: Aug. 21, 2014

(54) HORIZON-BASED SETTLEMENT OF DEFINED BENEFIT PENSION PLAN LIABILITIES

(71) Applicant: Antonio Limjuco Tan-Torres, JR., Audubon, PA (US)

(72) Inventor: Antonio Limjuco Tan-Torres, JR., Audubon, PA (US)

(21) Appl. No.: 13/773,438

(22) Filed: Feb. 21, 2013

(51) Int. Cl. G06Q 10/10

(52) U.S. Cl. CPC G06Q 10/1057
USPC 705/4

(57) ABSTRACT

A computer-implemented method settles a partition of a set of liabilities of a defined benefit pension plan arising from projected benefit payments promised to all or a subset of plan participants including pension benefits and other post-retirement benefits. The method includes calculating by the computer system the set of pension liabilities including the required benefit payments for each future year in the lifetime horizon of each participant in the entire or subset of the membership roster of the defined benefit pension plan using projected values based on the plan's specific benefit provisions, where the projected benefit payments are based on one or more assumptions including mortality, morbidity or survivorship. The method also includes specifying a settlement horizon comprised of partitions of the projected future lifetimes of participants over the membership roster, and calculating by the computer system the projected benefit payments within the settlement horizon.

### FIELD OF THE INVENTION

This invention relates to the field of financial management of liabilities of defined benefit pension and retirement plans, specific to enhancing the security of plans' promised benefits.

### BACKGROUND OF THE INVENTION

The invention relates to the field of financial management of liabilities of defined benefit pension and retirement plans, specific to enhancing the security of plans' promised benefits. Defined benefit pension funds in the corporate and public sectors promise specified amounts of benefits to participants upon reaching allowed retirement ages, as well as satisfying minimum service requirements. The promised benefit generally depends on the age at retirement, years of service, and may depend on the participant's compensation over a specified period of employment. The financial obligations of pension funds generally continue over an extended period of time, potentially extending 80 years or more. Retirement plans may owe current 20-year old participants promised retirement payments throughout their entire lifetime that could possibly reach 100 years or more.

To avoid excessive cash requirements when benefits become due in the future and to take advantage of tax incentives available in the tax code for corporate plans, plan sponsors pre-fund the obligation, resulting in significant asset pools that need to be invested appropriately. In the process of managing pension plan assets, plan trustees, investment committee members and investment consultants make recommendations and decisions regarding issues such as the fund's asset allocation, overlay investment strategies, choice of investment managers, the timing of such decisions. In addition to setting investment policies and strategies, plan sponsors also make decisions on additional defined benefit plan policies that have significant impact on the security of promised benefits. Additional policies that require consideration are employer contribution funding policy, benefit setting and settling policy and actuarial methods and assumptions setting policy.

Unfortunately, a significant number of corporate and state defined benefit plans are currently in difficult underfunded positions. This situation evolved over several years and was initiated by the so-called “pension perfect storm” of 2000-2002, where equity markets earned negative returns, while long yields declined to historical lows, thereby depressing discount rates and raising pension liabilities. The pension plans achieved considerable funding improvement over 2003-2007, but faltered again in the 2008 financial crisis when some equity benchmark indices lost over a third of their value.

Adding to the pressure on plan sponsors in 2006, Congress approved the Pension Protection Act which mandated stricter minimum funding for pension plans. The underfunding problems persist today, leading many plan sponsors to utilize available options within the various policies they have control over. With respect to investment policy, some plan sponsors initiated liability-driven investing (LDI) with the objective of more closely matching asset portfolio returns with liability behavior. On the benefits setting policy-side, some plan sponsors had to close to new entrants, as well as freeze benefits for ongoing participants. On the benefits settling policy-side, plan sponsors have looked to insurance companies to settle all liabilities promised to a subset of individual plan members, typically those already receiving benefits from the plan. Plan sponsors are hoping that such moves will alleviate the level and volatility of required cash contributions as well as pension accounting expense and consequently reduce the economic consequences of the pension plan on the total enterprise.

However even as plan sponsors are taking steps to ease the volatility as described in the prior paragraph, existing pension liabilities are still very much significant and will require continued risk management over the next decades. New alternatives that broaden the options for plan sponsors with respect to the various risk management policies they control can only help the plans in the future

In addition to the plan sponsors themselves, other parties of interest such as stock, sector or industry analysts in the investment field are very much interested in the financial risk management of pension plans of publicly traded companies that they cover, due to the increasing impact of the pension fund on the financial well-being of the enterprise. In December 2003, the Financial Accounting Standard Board (FASB) revised Financial Accounting Standard 132 (“Employers' Disclosures About Pensions and Other Post-Retirement Benefits”). A new requirement was the disclosure of the pension plans' asset allocation policy. Another party that monitors pension risk would be pension regulators such as the Pension Benefit Guaranty Corporation (PBGC), the agency responsible for guaranteeing pension payments in the US private sector. A similar agency in the United Kingdom (UK) would be the UK Pension Protection Fund. Rating agencies following the financial health of states, cities and municipalities also follow closely the pension funds in the public sector.

### BRIEF SUMMARY OF THE INVENTION

The invention covers a method of settling defined benefit plan liabilities wherein the method introduces a settlement-selection process that is horizon-based rather than the traditional participant-based settlement-selection algorithm. The method's settlement process results in the settlement of portions of individual participant's total pension liabilities specific to pre-selected horizons. The scope of participants involved may involve the total membership roster or alternatively, pre-selected subsets of the total membership roster.

The invention involves the selection by the plan sponsor of varied possible partitions of future horizon pension plan cash flows. The evaluation of the estimated cost, amount of actuarial liability settled and risk-reduction impact can then be used by the plan sponsor to determine the appropriate settlement horizon to implement. Moreover, projected pension plan benefit cash flows may vary from prior projections due to a variety of reasons including: (1) actual pension plan demographic experience diverging from actuarial assumptions, (2) new benefit accruals recently earned by ongoing active plan participants and (3) benefit plan amendments being implemented. Plan sponsors can also implement additional horizon settlements in the future after an initial horizon settlement. The invention includes processes for extending the method to cover implementation schedules for multiple applications of the method to apply to such variance benefit cash flows in previously settled horizons as well as additional benefit payment cash flows from previously unsettled horizons.

This invention presents a novel approach in the benefits settling policy which can then impact the investment and employer contribution policies that the plan sponsor may decide to pursue. In addition to plan sponsors, other external parties may be interested in the method including: a) Stock and bond analysts evaluating corporate pension plan risk of companies within the industries or sectors they cover; b) Credit rating agencies evaluating corporate and public pension plans and their impact on the credit worthiness of the entities they follow; c) Regulatory agencies such as the Pension Benefit Guaranty Corporation (PBGC) in the US and the Pension Protection Fund in the UK d) Accounting standards board such as the FASB and GASB charged with promulgating the proper disclosure of all sources of enterprise risk including pensions.

The invention can also be used in the context of other retirement related benefits, such as post-retirement medical and insurance benefits that are commonly provided by private and public employers. Moreover, the invention can be extended to cover enterprise liabilities that are uncertain and contingent on factors that may be hedged in varying degrees by available enterprise assets assigned to cover such liabilities.

In addition to the method, a computer software product for use on a computer system to implement the method is developed. The software is designed to perform the steps specified in the Detailed Description. The invention's other features and advantages will be apparent from the following detailed description, and from the claims. The details of one or more aspects of the invention are presented in the accompanying drawings and the description below. Other features, objects, and advantages of the invention will be apparent from the description and drawings, and from the claims.

A computer-implemented method settles a partition of a set of liabilities of a defined benefit pension plan arising from projected benefit payments promised to all or a subset of plan participants including pension benefits and other post-retirement benefits, the method being performed on a computer system having an output device. The method includes calculating by the computer system the set of pension liabilities including the required benefit payments for each future year in the lifetime horizon of each participant in the entire or subset of the membership roster of the defined benefit pension plan using projected values based on the plan's specific benefit provisions, where the projected benefit payments are based on one or more assumptions including mortality, morbidity or survivorship. The method also includes specifying a settlement horizon comprised of partitions of the projected future lifetimes of participants over the membership roster, and calculating by the computer system the projected benefit payments within the settlement horizon. The computer system outputs a representation of the projected benefit cash flows within the settlement horizon. The defined benefit pension plan liabilities are settled within the settlement horizon by the purchase of one or more annuities from one or more eligible insurance companies or alternative annuity providers.

A schedule of implementation points in the future is scheduled for a re-application of the method by recalculating by the computer system the updated projected benefit payments in a previously settled horizon using updated plan benefit provisions, updated participant roster and updated deterministic or stochastic assumptions, and by calculation by the computer system the variance between the re-calculated benefit payments and the previously settled benefit payments within previously settled horizons. The output device of the computer system outputs a representation of the variance benefit cash flows within previously settled horizons. The defined benefit pension plan liabilities arising from the variance benefit cash flows from within previously settled horizons are settled by the purchase of one or more annuities from one or more eligible insurance companies or alternative annuity providers.

A schedule of implementation points is scheduled in the future, the schedule specifying settlement horizons that have not previously been settled from prior applications of the method

### DESCRIPTION OF FIGURES

FIG. 1 depicts a possible sample representation by the computer system of the projected benefit cash flows from a sample defined benefit pension plan over the entire plan membership roster.

FIG. 2 depicts a possible sample, more granular representation of the projected benefit cash flows of the sample defined benefit pension plan over the entire plan membership roster.

FIG. 3 depicts a possible sample representation of a cost/benefit analysis chart for the evaluation of alternative horizon-based settlements for a defined benefit pension plan.

FIG. 4 depicts a possible sample representation by the computer system of the projected benefit cash flows for a sample settlement horizon selected by a plan sponsor.

FIG. 5 depicts another possible sample, more granular representation by the computer system of the projected benefit cash flows for a different sample settlement horizon selected by a plan sponsor.

FIG. 6 depicts a possible sample representation of the analysis sheet of an exemplary horizon-based settlement comparative matrix.

FIG. 7 depicts a possible sample representation of a schedule specifying future implementation points for the re-application of the horizon-based settlement method.

FIG. 8 depicts a possible sample representation of a decision matrix involving an exemplary horizon-based settlement comparative matrix, alternative asset allocations and investment overlay strategies

FIG. 9 depicts a possible sample representation of an inter-company defined benefit pension plan comparative matrix involving exemplary horizon-based settlements, alternative asset allocations and investment overlay strategies.

### DETAILED DESCRIPTION OF THE INVENTION

The understanding of following discussion of the invention may be facilitated by reference to the prior drawings.

1. Computer System Calculation of Pension Benefit Payments and Liabilities

A pension liability is the discounted value of a series of projected cash flows from benefit payments payable to plan participants and beneficiaries. The bulk of the payments are retirement benefits payable to surviving retirees. However, benefits may also be paid due to death, disability or employment turnover. Given the plan membership roster, the calculations of these benefits are prescribed in the pension plan document. Any anticipated changes to benefit provisions may be integrated into the calculations. While the plan document dictates the benefit payable should the participant experience the required contingency (retirement, death, disability, turnover), the probability of the contingency actually occurring may be factored in the liability calculation. Rates of mortality, disability, turnover and retirement at individual ages are typical inputs.

When calculating cash flows or liabilities at a future valuation date, inputs on assumed experience with respect to the above contingencies may also be required. In addition to the above, the membership roster of the pension plan, including age, service, pay if needed, for active participants, and age, amount and type of benefits for retirees, beneficiaries and vested terminations may be needed for detailed calculation. Summarized scatters of the participants may be used for less accurate estimates. Assumptions on new participants with respect to pay and age may be needed if liabilities at future valuation dates are calculated.

In calculating benefit payments and pension liabilities, the contingencies of survivorship, mortality, disability, turnover, wage inflation and retirement are generally used and typically are set to deterministic values, resulting in deterministic benefit cash flows. However, these various contingency rates may be treated as random variables; in this case, the cash flows become random variables. While the bulk of the discussion of the invention treats pension cash flows as deterministic, the extension to random variable cash flows is intended to be within the scope of the present invention.

Rather than the summary measures of statistical distributions when using stochastic models of the contingencies listed above, an alternative aspect of the method may use as inputs a plurality of Monte Carlo Simulations for each of the required random variables. Among the plurality of Monte Carlo simulations that may serve as inputs to the cash flow projection are: (1) simulations of survival-related contingency rates such as mortality and morbidity and (2) benefit-related variables such as wage rate growth if required for calculating future benefit payments.

From these deterministic or stochastic (random) inputs, cash flows may be calculated using actuarial routines. Rather than being calculated, the cash flows may also be direct inputs if provided by an external source such as the plan actuary. In addition, a similar process may be used to calculate post-retirement benefits other than pensions. The method may also be readily extended to other enterprise liabilities which can be modeled as future streams of cash flows, in the same manner as benefit cash flows for pension liabilities.

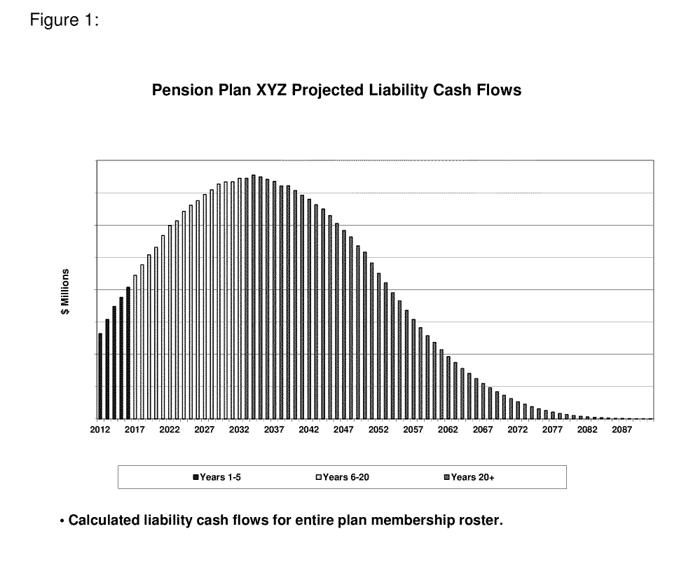

FIG. 1 illustrates a sample representation by the computer system of the projected benefit cash flows from a sample defined benefit pension plan over the entire plan membership roster. The benefit cash flows generally include retired participants who are already receiving benefits, participants who are promised benefits deferred into the future (vested terminations) and participants still earning retirement benefits. Projected benefit payments can extend as far out as 75 years or more as shown in the horizontal axis.

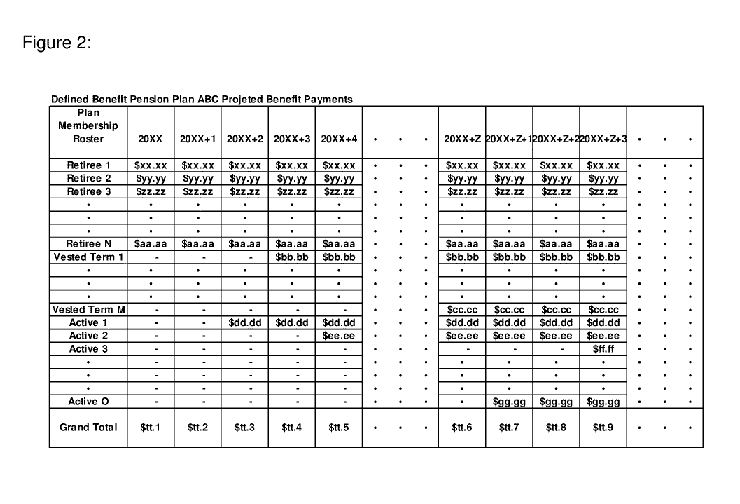

FIG. 2 displays another sample representation by the computer system of the projected benefit payments over the entire plan membership roster on a more granular, detailed level. Plan participants are listed individually in rows, and may be arranged by payment status (e.g. retired, terminated vested, active). Across columns, anticipated benefit payments are projected. Summing over the benefit row for each column presents the total benefit projected for the particular year (column).

2. Horizon-Based Settlement

Current settlement practice for defined benefit plans involves the selection of one or more selected participants in the membership roster for whom one or more annuities are purchased to meet the total obligations over the entire lifetimes for each selected participant. Under this mode of settlement, the selection algorithm is participant-based, where partitions of the total membership roster can result in the settlement of all projected benefit cash flows for the selected individual members. Current practice of settling a portion of the total plan liability will initially prioritize participants currently receiving benefits (retirees and beneficiaries) for settlement. Since these benefit payments are already in pay status, the corresponding liabilities and settlement costs are the largest relative to other plan participants in the membership roster not yet receiving benefits. This high cost consideration of the current methodology can serve to dissuade underfunded plan sponsors from adopting this settlement approach.

Rather than the settlement-selection algorithm being participant-based, the method of the invention innovates by introducing a settlement-selection process that is horizon-based. In this method, the novel settlement process results in the settlement of portions of individual participant's total pension liabilities specific to pre-selected horizons. The scope of participants involved may involve the total membership roster or alternatively, pre-selected subsets of the total membership roster.

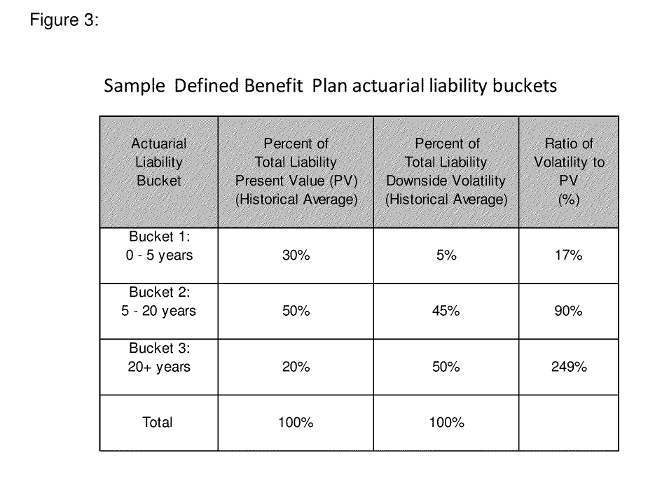

FIG. 3 illustrates the advantages which may be allowed by the invention. FIG. 3 shows 3 different potential settlement horizons as represented by the 3 actuarial liability buckets for a sample defined benefit pension plan. For this plan, column 2 shows liability buckets 1, 2 and 3 comprise 30%, 50% and 20% of the total plan liability, respectively. This partition of the total actuarial liability provides the plan sponsor with the relative magnitude of the estimated cost of 3 different settlement horizons. A risk-averse plan sponsor can evaluate the last 2 rows of FIG. 3 to compare the relative merits of the 3 settlement horizons that can settle corresponding liability buckets. Column 3 shows that despite bucket 3 having the least amount of liabilities, it is responsible for the greatest amount of liability volatility among the 3 buckets. This is significant to the plan sponsor since this settlement horizon for this plan has the double advantage of: (1) costing the least, and (2) taking out the most volatility. Column 4 provides a cost/benefit metric that the plan sponsor can use to compare the different settlement horizons. This system can be extended to compare horizon-based settlements to traditional, non-horizon based liability settlements.

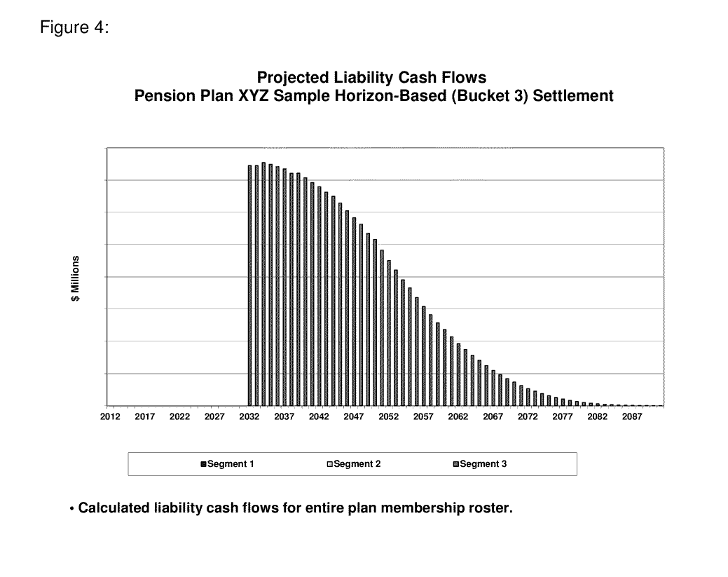

FIG. 4 displays one aspect of the method involving a settlement-horizon of projected benefit cash flows due 20 years or later from the present for the total membership roster. Since the benefit cash flows will only be payable 20 years out under this aspect, the settlement cost is lower relative to the traditional approach of settling benefit payments in current pay status. The cost advantage of this horizon-based settlement method may allow previously hesitant underfunded plan sponsors to implement a settlement.

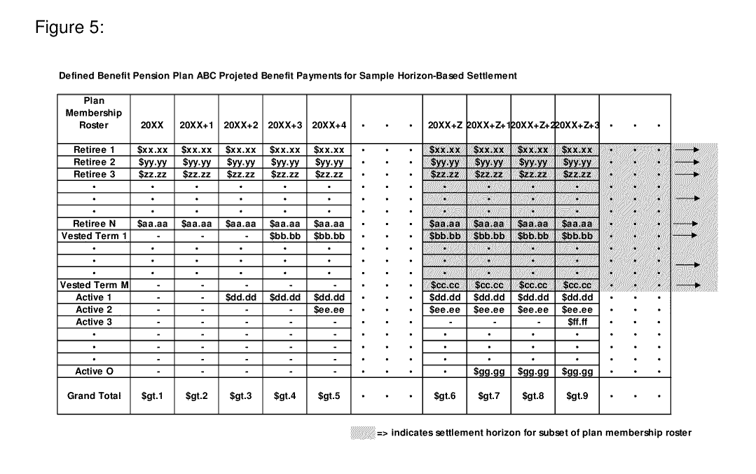

FIG. 5 displays another aspect of the method involving a settlement-horizon of projected benefit cash flows. FIG. 5 displays another exemplary representation by the computer system of the horizon-based settlement method showing projected benefit payments for a sample horizon-based settlement over a subset of the entire plan membership roster on a more granular, detailed level. The shaded portion of the diagram indicates the sample settlement horizon for this subset of plan membership roster.

While the discussion in this section discussed settling retirement benefits, extensions to settling other benefit obligations will be readily apparent to those skilled in the art. Such extensions are intended to be within the scope of the present invention.

3. Horizon-based Settlement Comparative Matrix

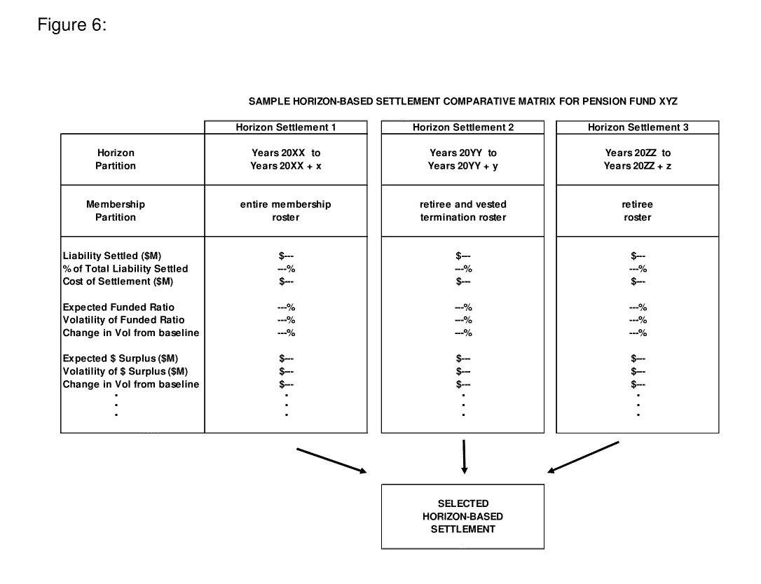

Due to the flexibility and cost-advantages of the method, plan sponsors can review various horizon alternatives in considering this settlement method. The computer system can be extended by those skilled in the art to calculate and display multiple settlements for a pension plan varying by settlement horizons. FIG. 6 shows a sample representation by the computer system of a comparative matrix of different horizon-based settlement options that a plan sponsor may consider. The computer system can provide metrics including settlement cost, expected levels and volatility of funded ratio and dollar surplus that can assist plan sponsors in deciding the appropriate horizon-based settlement for the plan.

While the example above uses expected dollar surplus, standard deviation of dollar surplus and pension, additional comparative metrics apparent to those skilled in the art may be included in the representation in FIG. 6 and are intended to be within the scope of the invention.

4. Implementation Schedule for Horizon-Based Settlement for Variance Benefit Payments

During the ongoing operation of the pension plan, projected benefit payment projections calculated by the computer system may vary compared to benefit payments projected in the past. There may be multiple possible causes for this variance in projected benefit payments. Among the reasons are: (1) for defined benefit pension plans offering continuing benefit accruals, the projected benefit payments increase due to additional credited service for active plan participants; (2) the defined benefit pension plan's demographic experience actually realized may vary from the survival assumptions used when benefits were projected in the past, resulting in projected benefits varying from benefit projections calculated in the past; (3) the defined benefit pension plan may introduce amendments to the benefit provisions, thereby revising future benefit payments

Due to these variance benefit cash flows, horizons that were settled in prior implementations of this method may contain new liabilities that are not yet settled. Claim 2 extends the method of claim 1 by including a schedule of implementation points to re-apply horizon-based settlements to the variance benefit payments due in previously settled horizons. Other factors causing variance benefit payments will be readily apparent to those skilled in the art; such extensions are intended to be within the scope of the present invention.

5. Implementation Schedule for Horizon-Based Settlement for Extension to New Settlement Horizons

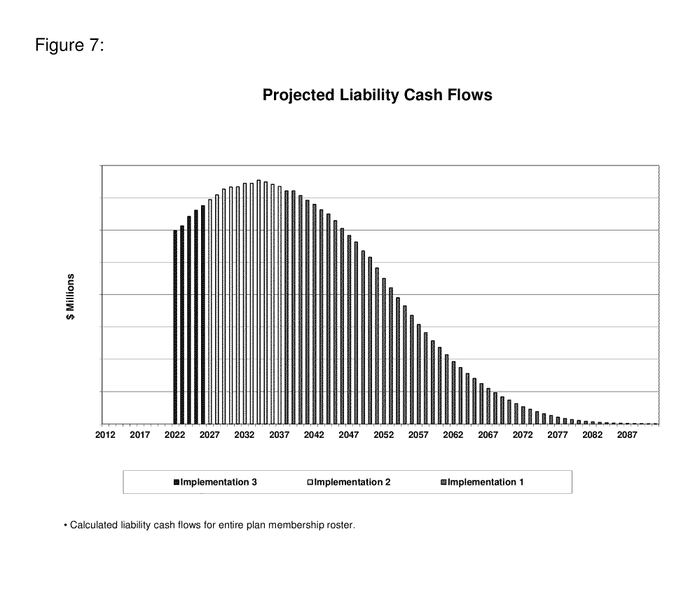

During the ongoing operation of the pension plan, the plan sponsor may extend horizon-based settlements on previously unsettled horizons. Claim 3 extends the method of claim 1 by including a schedule of implementation points to apply horizon-based settlements to projected benefit payments due in previously unsettled horizons. FIG. 7 displays a sample representation of a 3-step implementation schedule for horizon-based settlements targeting varying horizons.

6. Further Discussion on Integrating Horizon-Based Settlement Method in Setting Investment Policy, Benefit Provisions and Other Pension Fund Policies

Pension plan sponsors perform analysis on other pension plan-related issues, such as deciding pension plan investment policy and overlays, revising benefit plan provisions, setting employer contribution policy and selecting actuarial assumptions and methods. The horizon-based settlement process may be utilized to set such other pension fund policies; such use is claimed within the scope of the present invention as defined in the appended claims.

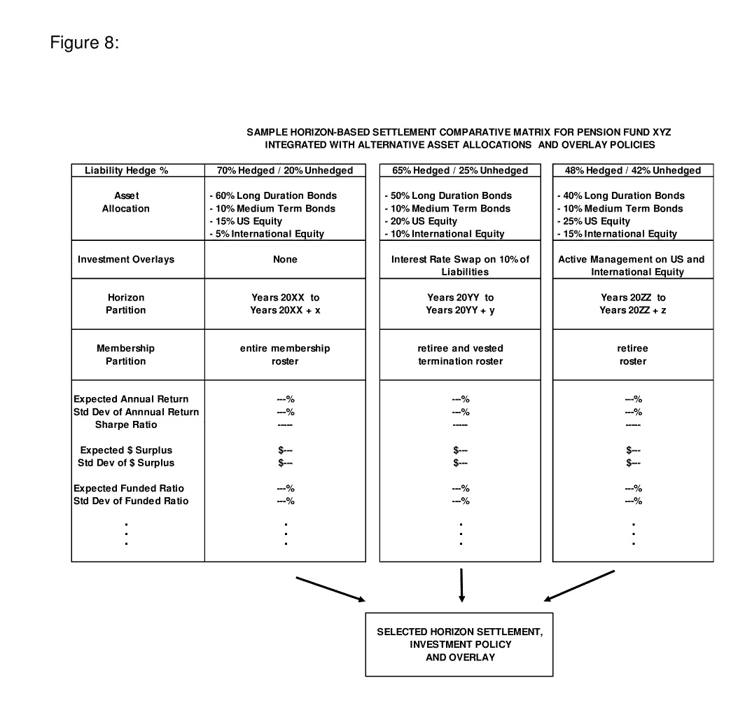

FIG. 8 shows a sample representation from the computer system which displays an exemplary integration of varied horizon-based settlement strategies with different investment policy/asset overlay alternatives. Additions of other comparative metrics apparent to those skilled in the art may be included in the representation in FIG. 8 and are intended to be within the scope of the invention.

7. Use of Methods by Other Interested Parties

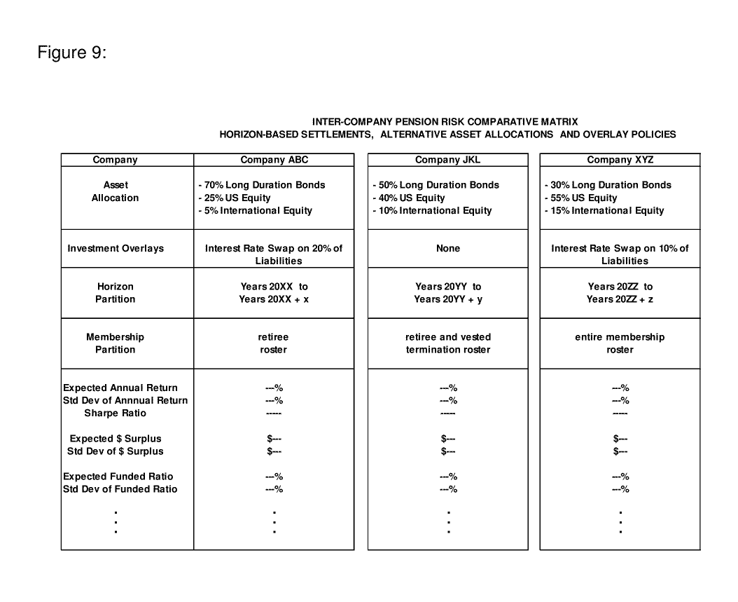

The funding insecurity of pension plans and the potential negative impact on the enterprise sponsoring the plans have led other interested parties in evaluating the risk presented by the pension plan(s) of the enterprise. Such interested parties may favorably view the plan sponsor's use of the horizon-based settlement method in evaluating one or more pension plans of the entities they monitor. Examples are: a) Stock and bond analysts evaluating corporate pension plan risk of companies within the industries or sectors they cover; FIG. 9 provides an example how an analyst might assess and compare pension risk before and after the implementation of a horizon-based settlement for a portion of the plan's liabilities; b) Credit rating agencies evaluating corporate and public pension plans and their impact on the credit worthiness of the entities they follow; c) Regulatory agencies such as the Pension Benefit Guaranty Corporation (PBGC) in the US and the Pension Protection Fund in the UK which are responsible for guaranteeing pension payments in their respective private sectors; d) Accounting standards board such as the FASB and GASB that is charged with promulgating the proper disclosure of all sources of enterprise risk including pensions. The use of the horizon-based settlement method for plans of one or multiple entities is intended to be within the scope of the present invention as defined in the appended claims.

8. Use of Method in Other Enterprise Liabilities

Corporations and public entities offer benefits other than pensions to employees who retire from their employment. Examples of these are post-retirement medical and life insurance benefits. Employers face similar issues in terms of funding these liabilities as well as disclosing in their financial statements. It is possible to settle partitions of these liabilities using eligible external benefit providers. Extensions of the horizon-based settlement method to post-retirement benefit plans other than pensions are intended to be within the scope of the present invention as defined in the appended claims.

Moreover, enterprises may have other liabilities outside of the benefit liabilities discussed. An enterprise can easily have other liabilities consisting of future projected cash flows. The enterprise may settle partitions of such future cash flows with eligible external providers. The extensions of the horizon-based settlement method to such other enterprise liabilities and assets will be readily apparent to those skilled in the art and are intended to be within the scope of the present invention as defined in the appended claims.

9. Computer Systems

In addition to the method, a computer software system for use on a computer processing system to implement the method is developed. The software is designed to perform the steps for: a) calculating the projected liability of the defined benefit pension plan specified as projected benefit payments for each of the future years in the participants' lifetimes; b) calculating the subset of projected benefit cash flows for the portion of the membership plan roster that is intended for settlement; c) calculation of the subset of projected cash flows for the designated portion of the membership plan roster specific to the target settlement horizon; d) calculation of the variance benefit cash flows when implementing the method after the initial horizon settlement; e) displaying the horizon settlement cash flows for review by eligible insurance companies and other potential annuity providers; (f) calculation of the actuarial liability, estimated cost, risk reduction impact and other relevant metrics for the evaluation of alternative settlement horizons; (g) production of charts and graphs relevant for the evaluation of alternative settlement horizons

10. Extensions of the Method

Although the invention has been described with reference to the specific techniques for settling defined benefit plan liabilities for all or a partition of the pension plan's membership roster over the settlement horizon, the invention is not limited to reliance on such techniques. Various modifications, additions or improvements may be devised or recognized by those skilled in the art; and such modifications, additions or improvements are properly considered as extensions of the method that are within, or equivalent to, the scope of the invention as defined by the appended claims.

I claim:

1. A computer-implemented method for settling a partition of a set of liabilities of a defined benefit pension plan arising from projected benefit payments promised to all or a subset of plan participants including pension benefits and other post-retirement benefits, the method being performed on a computer system having an output device, comprising:
(A) calculating by the computer system the set of pension liabilities including the required benefit payments for each future year in the lifetime horizon of each participant in the entire or subset of the membership roster of the defined benefit pension plan using projected values based on the plan's specific benefit provisions, where said projected benefit payments are based on one or more assumptions including mortality, morbidity or survivorship;
(B) specifying a settlement horizon comprised of partitions of the projected future lifetimes of participants over the membership roster;
(C) calculating by the computer system the projected benefit payments within the settlement horizon;
(D) outputting by the computer system a representation of the projected benefit cash flows within the settlement horizon;
(E) settling of the defined benefit pension plan liabilities within the settlement horizon by the purchase of one or more annuities from one or more eligible insurance companies or alternative annuity providers.

2. The method of claim 1, further comprising:
(F) specifying a schedule of implementation points in the future for a re-application of the method of claim 1;
(G) recalculating by the computer system the updated projected benefit payments in a previously settled horizon using updated plan benefit provisions, updated participant roster and updated deterministic or stochastic assumptions;
(H) calculation by the computer system of the variance between the re-calculated benefit payments and the previously settled benefit payments within previously settled horizons;
(I) outputting by the output device of the computer system a representation of the variance benefit cash flows within previously settled horizons;
(J) settling of the defined benefit pension plan liabilities arising from the variance benefit cash flows within previously settled horizons by the purchase of one or more annuities from one or more eligible insurance companies or alternative annuity providers.

3. The method of claim 1, further comprising:
(K) specifying a schedule of implementation points in the future for the re-application of the method of claim 1;
(L) said schedule specifying settlement horizons that have not previously been settled from prior applications of the method.
